(19) United States
(12) Patent Application Publication
(10) Pub. No.: US 2006/0161268 A1
(43) Pub. Date: Jul. 20, 2006

(54) System for operating and monitoring having integrated historian functionality

(76) Inventors: Burkhard Frensch, Lauf (DE); Roland Heymann, Erlangen (DE); Frank Volkmann, Nurnberg (DE)

Correspondence Address: Siemens Corporation;Intellectual Property Department, 170 Wood Avenue South, Iselin, NJ, 08830, US

(21) Appl. No.: 10/527,915

(22) PCT Filed: Sep. 1, 2003
(86) PCT No.: PCT/DE03/02887

§ 371 Date: Dec. 2, 2005

(30) Foreign Application Priority Data
Sep. 16, 2002 (DE) 102 43 065.9

(51) Int. Cl. G05B 15/00

(52) U.S. Cl. 700/1

(57) ABSTRACT

The invention relates to a system for operating and monitoring a production process and for filing process data for a historian system, the operating and monitoring functionality and the historian functionality being integrated in a single system. A historian database is used for storing process data. The production process and data filed for the long term can be accessed in one system. The process data has to be collected only once by the respective devices. The historian system takes advantage of the redundancy of the operating and monitoring system, special multiplexer components transparently covering up underlying systems. The inventive system is internet compatible and can be used by any clients. Commercially available historian clients can be used in internet scenarios by remoting the database interfaces.

### CROSS REFERENCE TO RELATED APPLICATIONS

This application is the US National Stage of International Application No. PCT/DE2003/002887, filed Sep. 1, 2003 and claims the benefit thereof. The International Application claims the benefits of German application No. 10243065.9 filed Sep. 16, 2002, both applications are incorporated by reference herein in their entirety.

### FIELD OF THE INVENTION

The invention relates to a system for operating and monitoring a production process, said system having an integrated database for filing the process information data.

In modern production installations, in particular in the processing industry, ever-increasing volumes of data arise during the production process owing to the growing use of intelligent field devices. Said data is used partially directly in systems for operating and monitoring (also HMI or SCADA systems) for monitoring and controlling the respective production process. Data concerning the production process is, however, similarly also used by what are termed historian systems or, as the case may be, systems for managing the plant information (Plant Information Management System, PIMS) in such a manner that the data is filed in high-performance databases and is available for subsequent analysis with the aid of statistical evaluation systems.

The systems currently employed for operating and monitoring (O&M systems) therefore acquire process data in order to display the momentary values in, for example, graphical form. The O&M systems moreover also generate alarms and events from the data. They also file the process values, insofar as is necessary for a subsequent display. Filing typically takes place in a proprietary manner in a separate file system.

Graphical representing of the process data can be carried out on what are termed O&M clients. Proprietary interfaces are as a rule employed for this. It is extremely important for O&M systems to ensure high-availability plant operation at all times. They therefore offer highly developed redundancy mechanisms and allow the functionality to be distributed even over the internet. Large systems for operating and monitoring are, moreover, frequently distributed systems in order to take the plant's topology into account. As a result, data logging, report derivation, and filing are also distributed. However, systems for operating and monitoring offer mechanisms for the clients rendering this distribution transparent.

The plant information management systems (PIMS) used by industry today serve to acquire process data very fast and centrally. Said data is as a rule stored in a database. The clients of said systems, for example simple database clients, will then be able to interrogate said data later via standard interfaces (ODBC, OLE DB, ADO, SQL, and the like) and further process it. The main focus here is on accessing via a generic interface. Redundancy mechanisms and accessing of the historical data over the internet are non-existent.

### SUMMARY OF THE INVENTION

O&M and historian systems both access the same process data. The required data therefore has to be fetched twice from the relevant data sources. This burdens both the data sources, which is to say control devices and sensors, and the respective communication paths such as, for example, networks. The data used by the two systems is not synchronized because the acquiring system as a rule issues a time stamp and synchronizing between both systems or, as the case may be, time stamps would require a substantial expenditure. The currently necessary double configuring of the overall system is also demanding in terms of expenditure because, for example, acquisition cycles have to be planned twice. The redundancy and the transparency of distribution in the logging and filing of process data that are made available by, for example, an O&M system are not used for the historian clients and can only be implemented by means of expenditure-intensive cluster mechanisms (of the operating system or database), hardware redundancy, and explicit distribution planning. Internet access to the historian database supported by network mechanisms such as proxy servers or firewalls is not possible over the standard interfaces, such as, for example, ODBC.

The object of the invention is to disclose a system enabling simple and non-site-specific operation and monitoring of a plant and serving simultaneously to permanently file and/or archive process data for analysis and the application of evaluation methods.

Said object is achieved by means of a system for operating and monitoring a production process, said system having first means for provisioning automation devices or, as the case may be, systems and/or diagnostic devices or, as the case may be, systems and/or further devices for acquiring process information data, a device for editing and/or representing the acquired process information data for at least one user of the system, and a historian database for filing the acquired process information data for evaluating and/or representing the filed process information data.

The invention is based on the knowledge that the separation currently prevailing between the systems for operating and monitoring a plant or, as the case may be, a process and the plant information management systems, which is to say the historian systems, gives rise to increased expenditure requirements in acquiring the process data or in the planning of, for example, process communication or a security system.

The advantage of the presented embodiment according to the invention is that the characteristics or, as the case may be, advantages of O&M systems and historian systems are combined.

The system for operating and monitoring is herein expanded in such a manner as to offer historian functionality in addition to its original functionality and also vice versa. This means that the O&M process communication is used to file the acquired process information data on a high-performance basis in a database contained locally in the HMI or, as the case may be, vice versa, that the data acquired by the historian system for long-term filing is used in an integrated O&M system. The O&M system herein co-assumes the functions of the hitherto separate filing system or, as the case may be, vice versa. An efficient historian is hence combined with the functionalities of a modern HMI system. A scalable historian functionality is thereby available ranging from a simple HMI standalone system to a cross-corporate solution that is also used in process control systems. The database herein serves as a central information exchange in a company or, as the case may be, for a plant and places particular requirements on performance, availability, and security. Efficient mechanisms are implemented herein that far exceed the function of a standard database and render the database suitable for industrial use without having to accept the limitations in terms of the openness and standard of, for example, a Microsoft SQL server. Data compression, various options for redundancy that is transparent for the application and for users, online modifiability, and long-term filing are integrated in the basic system. Expensive duplicate entries and the time-consuming maintenance of planning data are effectively obviated as the historian is an integral part of the HMI system. Data is acquired from the automation systems via standard interfaces, or also from databases, then aggregated and filed. The consequence of linking the HMI and historian into a single application is also, however, that data has to be acquired only once from the information sources, which is to say the automation devices or, as the case may be, diagnostic devices. This results in reduced loading of the network and sources. It furthermore ensures consistency of the filed data. [lacuna] have a possibility of logging and displaying the security status. Plant operators are hereby enabled at all times to monitor the security status of parts of their plant's automation.

A further advantageous embodiment of the invention is characterized in that the system is provided for coupling to the automation devices or, as the case may be, systems and/or diagnostic devices or, as the case may be, systems and/or further devices via a data transmission device. The system according to the invention can be installed at any location on the plant and receives the necessary process information data for example over an Ethernet, a bus system, or any other device serving to transmit data from the field devices to the O&M system. Alongside its non-site-specific characteristic, the system's flexibility is also advantageous since additional field devices can be connected to the data transmission device at any time.

A further advantageous embodiment of the invention is characterized in that the system has second means for generating alarms and/or events. The integration of a security system of said type which makes the acquired real-time information data available for generating alarms or events for an operator and monitor of the plant as a function of the respective planning is advantageous since a plant operator can be immediately warned if certain parameters within the production process do not accord with the requirements. The operator will be able to react immediately and intervene in the production process or, as the case may be, re-adjust a should-be value in the event of a false alarm. The system for operating and monitoring thus draws a plant operator's attention, by means of particular information, to the fact that a certain situation has arisen, possibly an exceptional situation, requiring an immediate response on the part of the plant operator.

A further advantageous embodiment of the invention is characterized in that the system has at least one interface for communicating with at least one client. It is herein advantageous that a plant operator does not have to work directly on a PC or [lacuna] on which the system for operating and monitoring the plant is installed. The real-time data and its corresponding graphical representation can also be accessed from a client at any other location. A certain degree of mobility is thereby provided in operating the plant. Said embodiment of the invention furthermore has the advantage that in the case of a distributed plant the actual HMI system has to be installed only once on an efficient machine, while plant operators are able to access said system independently of each other from several clients. Distributed operation of the system is hence also made possible.

A further advantageous embodiment of the invention is characterized in that the client is provided as a web client for communicating over the internet and/or an intranet. The advantage of this embodiment of the invention is that the process information data for operating and monitoring can also be accessed from remoter locations, for example when a plant consists of a plurality of sub-plants or when a company is spread across different locations. Company management is thereby enabled also to call up the production data centrally.

A further advantageous embodiment of the invention is characterized in that a browser is provided as the web client. It is advantageous when a browser is used that any internet-enabled client can be employed for using the system for operating and monitoring a plant. The client can hence be what is termed a thin client. The evaluation functionality required for the system for operating and monitoring is herein made available by the system for operating and monitoring itself via a communication network, which is to say, for example, over the www. Availability of information is thus ensured at any time and at any location through the use of a simple web browser.

A further advantageous embodiment of the invention is characterized in that the clients and/or the web clients are embodied as SCADA clients of the system for operating and monitoring. It is herein advantageous that SCADA clients already installed for operating and monitoring the system can also be used in the future for, for example, accessing the filed data newly stored in the system via the clients. The SCADA clients thus also serve as operating stations for the filing system. In addition to access to the current plant status, historical process data and alarms are also made visible for the user via the client in the form of trends and tables. Already existing analysis functionalities, such as filter conditions and sorting criteria in the client's various visualizing objects, are herein also available.

A further advantageous embodiment of the invention is characterized in that the clients and/or the web clients are embodied as clients that are independent of the system for operating and monitoring. It is herein advantageous that independent clients, what are termed 3^{rd}-party components, which is to say, for instance, typical historian clients, have access to the filing system via the system for operating and monitoring a plant. It is therefore not necessary to replace any already existing historian clients having special analyzing and evaluating functionality. Said clients are supplied with the relevant process information data by way of remoting of, for example, the standard interfaces of the database. Accessing can, however, also take place herein via the proprietary interfaces of a system for operating and monitoring. Using the special historian clients as, for example, analysis clients is advantageous for analyzing the optimizing potential in the process. Data analyzing can be performed not only interactively but also as being triggered by events within the various processes within the company.

Combining the system for operating and monitoring a plant with the historian system and with the possibility of representing the combined system's data in a special analysis client ensures a better overview at all times of the relevant company.

A further advantageous embodiment of the invention is characterized in that the independent clients are embodied as historian clients having analyzing and/or statistical and/or graphical functionality for evaluating and/or representing the filed process information data. Use of the relevant clients as, for example, report clients for printing and displaying pre-designed reports containing online data and historical data from all levels within a company is advantageous. Any data from databases, 3^{rd}-party applications, and also from the automation level can herein be included.

A further advantageous embodiment of the invention is characterized in that the functionality of the independent clients is integrated in the SCADA clients of the system for operating and monitoring. In this advantageous embodiment an analysis client's highly complex analyzing functionality and graphical functionality, for example, used specifically in a historian system is included in the user interface of the system for operating and monitoring. This enables the system for operating and monitoring to be used in such a manner with a single representation or, as the case may be, from a single client that the plant can be operated and monitored and that an overview of the historical filed data, which is to say, for example, trends, can simultaneously be provided extending over a number of years. The advantage herein is that it is not necessary to install different clients having different functionalities, which factor primarily constitutes an economical solution. It is, however, furthermore advantageous for a plant operator in, for example, an alarm situation requiring a response from said operator simultaneously to be able to access filed data and trends so as thereby to utilize available knowledge about the production process as experience for the response that is made. Using a combined client of this type thus makes it possible to provide the operator with a “process information data knowledgebase” at any time.

A further advantageous embodiment of the invention is characterized in that the functionality of the SCADA clients is integrated in the independent clients. Said embodiment enables standard clients as well as special clients suitable for data analysis to be used simultaneously for representing the functions specific to an O&M system. Monitoring and operating of the plant by, for example, a historian client is made possible since the special O&M user interface is integrated. Active intervention in the production process from the same client is also possible alongside passive information processing.

A further advantageous embodiment of the invention is characterized in that the functionality of the clients is integrated in standard applications, in particular office applications. Said embodiment makes it possible to implement what are termed management clients for displaying the historical data on standard office PCs having standard tools such as, for example, Microsoft Excel, so that company management can, whenever required, obtain an overview of the situation in the production sector at different times or, as the case may be, across different periods of time. Special pre-designed reports containing data compiled for management can herein be represented by the standard office applications. An overview, including one covering a company's various production sites, can therefore be generated at any time and anywhere on a standard PC.

A further advantageous embodiment of the invention is characterized in that the database is provided for fast and/or central filing of the acquired process information data. The database used for filing the process information data must be of high-performance type since process data comprising thousands of individual items has to be written into the system in a short time and filed there. Special requirements are therefore placed both on the performance of a database of said type and on its availability and security. In particular the structure of employing a central database is advantageous alongside high performance. Synchronicity of the filed data is ensured thereby. It is furthermore ensured that all consumers of information will access a uniform data inventory. A distributed storing of data and the attendant problem of synchronizing are avoided by means of said central database and the storing of data is achieved in an advantageous manner.

A further advantageous embodiment of the system is characterized in that the database is embodied as a relational database. High-speed storage facilities and data accessing are ensured thereby.

A further advantageous embodiment of the invention is characterized in that access to the database is provided by means of SQL queries via standard interfaces. It is herein advantageous that standard Microsoft technology can be employed. A Microsoft SQL server, for example, can be used for the database, with its then being possible for accessing to take place via, for example, OLE-DB, OPC, COM. The special development or, as the case may be, programming of specific interfaces to allow access to the database is rendered superfluous by this advantageous embodiment of the invention.

A further advantageous embodiment of the invention is characterized in that the process information data filed in the database is provided for accessing by clients communicating with the system. The clients, which is to say, for example, SCADA clients or special analysis clients, can directly access the data which is stored in the filing database. Direct provisioning of the respective users with filed process data is ensured thereby. External relocating of the data, buffering within a further system or in the system for operating and monitoring, and other intricate methods or mechanisms for making the data available are thereby rendered unnecessary. Rather it is the case that the data is accessed directly.

A further advantageous embodiment of the system is characterized in that remoting of the standard interfaces of the database (4) is provided. Remoting the standardized database interfaces (ODBC, OLE DB, ADO, SQL, and the like) makes it possible to use commercially available historian clients in remote internet scenarios. The clients can access the process information data directly.

A further advantageous embodiment of the system is characterized in that the system and the clients are provided for bi-directional web communication. Clients and the system for operating and monitoring can thus communicate with each other using standard HTTP protocols. It is herein advantageous that communication is bi-directional, which is to say the clients can, temporally independently in a process triggered by the server without a client request, both receive and appropriately represent data from the system for operating and monitoring and also send instructions to the system for operating and monitoring a plant which will then be executed there accordingly and, in certain circumstances, influence the production process. The production process can therefore as a result of this advantageous embodiment also be controlled remotely.

A further advantageous embodiment of the invention is characterized in that the clients are provided for entering specifications and/or should-be values for controlling the production process. It is herein advantageous that it is also possible for special values serving as, for example, threshold values for generating alarms and/or events to be changed or, as the case may be, adjusted remotely by the respective clients. Remote tuning of the plant is made possible by this advantageous embodiment.

A further advantageous embodiment of the invention is characterized in that the system for operating and monitoring is provided for managing users of the system and/or for planning process communication and/or a security system. It is herein advantageous that, for example, user rights and access rights are administered directly within and by the system. The system itself therefore has information as to whether, for instance, a specific user is authorized to re-adjust a should-be value for, for example, triggering an alarm. The system furthermore enables, uniform planning of, for example, communication structures or the security system. It is herein particularly advantageous that within the system the structures have to be planned only once and will thereafter be available for both the historian system and the system for operating and monitoring. Time-consuming duplicated planning is thereby rendered superfluous.

A further advantageous embodiment of the invention is characterized in that the system for operating and monitoring is of redundant design, with redundancy also existing for independent clients. Operation and monitoring of a plant having to be provided by the system at all times, a major prerequisite is for highly-developed redundancy mechanisms to be present in the system. Fast access to the data acquired from the automation systems or, as the case may be, diagnostic devices must be ensured so that working can resume immediately in the event of a total outage. Redundancy can herein be implemented by imaging the data in the system or by employing redundant hardware, such as servers, and through duplicated interrogation of the process information data from the sources. Additional burdening of the data lines is avoided when imaging is employed as the respective process information data has to be acquired once only. The historian system benefits in the case of the system according to the invention from the redundancy present in any event in the O&M system.

A further advantageous embodiment of the invention is characterized in that at least one multiplexer component is provided for concealing the redundancy and/or a plurality of data servers. The redundancy mechanisms (changeover of the servers/data sources) are transparent for the client. Concealment takes place in servers or in intermediate layers (proxies, multiplexers). In the event of an outage of, for example, a server, changeover will thereby be effected automatically to a redundant server and the users on the clients will continue to be supplied with the relevant information. They will not be affected by the component outage and no special measures will have to be launched to switch to the redundant server. Rather it is the case that changeover will take place without the clients' being apprised of the outage by the multiplexer.

The invention is described and explained in more detail below with the aid of the exemplary embodiment shown in the sole figure:

### BRIEF DESCRIPTION OF THE DRAWING

FIG. 1 shows a system for operating and monitoring a production process, said system having integrated historian functionality.

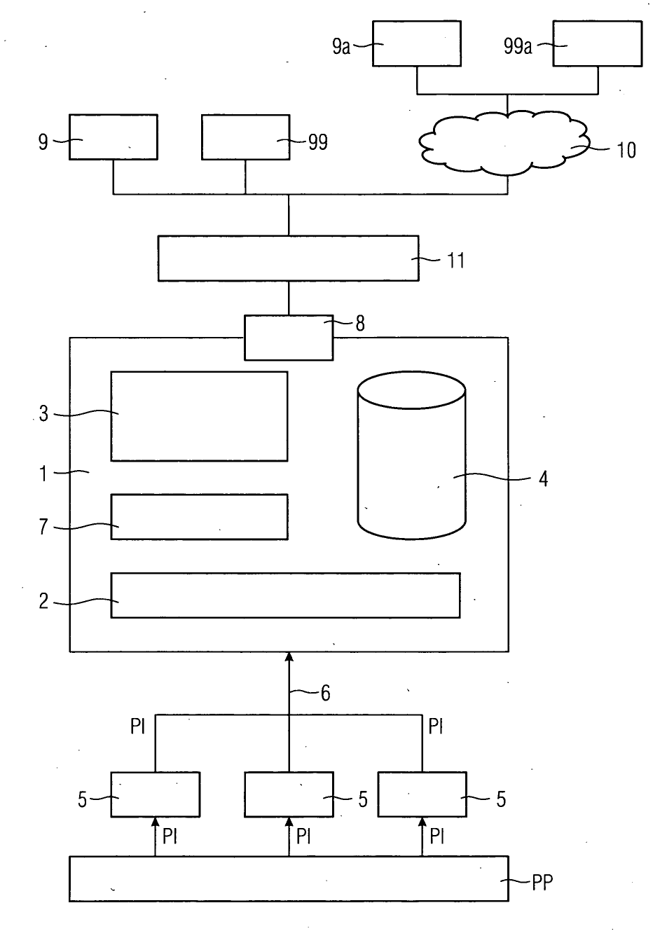

### DETAILED DESCRIPTION OF THE INVENTION

The system 1 acquires process information data PI from a production process PP. Said process information data PI comes from automation devices or, as the case may be, diagnostic devices 5. These can be control devices or sensors. The process information data PI is transmitted to the system 1 over a data transmission device 6. Said data transmission device 6 can be, for example, a bus system. The data is made available by the means 2 for real-time provisioning for use in the system 1. A device 3 for editing or representing the acquired process information data PI is present in the system 1. There is furthermore a database 4 for filing the acquired process information data PI. Said database can be a SQL server. The process information data can be used by further means 7 for generating alarms or events. The system 1 can communicate with clients 9, 9a, 99, 99a via an interface 8. This communication can take place over the internet 10. A multiplexer 11 enables concealment in the case of redundancy and/or a plurality of data servers.

In the exemplary embodiment of the invention shown in the figure the process data PI collected by automation devices or, as the case may be, diagnostic devices 5 during a production process PP is forwarded directly to a system for operating and monitoring 1. Alongside the use of bus systems, any communication networks such as, for example, transmission over the internet, is herein also conceivable as the data transmission device 6. The process information data PI is used by the system 1 for operating and monitoring to represent a current plant status for a user. A user can as a rule also influence the relevant production process PP via the system 1 by being able to address the control devices via the data transmission device 6. The re-adjustment of should-be values is, for example, herein conceivable. Similarly, it is possible via the system 1 for operating and monitoring to, for example, influence supplied quantities of various basic materials employed in the production process.

The system 1 is able to produce alarms or events on the basis of the acquired process data PP to make the user aware of special situations. Simple analyses of the process data are therefore possible through the means 7 for producing said alarms and events.

An extensive analysis of production processes over a longer period of time is likewise enabled by the system 1 as a result of the filing of all process information data PI within the system 1 on a database 4. All measurements taken from the production process are stored in the database 4. Fast access to the historical data also describing a production process PP over a longer period of time is thus possible at any time over the system for operating and monitoring. Analysis such as, for example, comparing different batches, is hereby made possible by the system 1.

The process information data PI acquired from the automation devices or, as the case may be, diagnostic devices 5 is therefore used by the system both for representing the current plant status and for filing for the purpose of subsequent detailed analysis. The data therefore has to be collected once only.

Any clients 9 such as, for example, special clients for operating and monitoring such as SCADA clients or web-enabled clients 9a such as, for example, a web navigator for a system for operating and monitoring can be connected to the system 1 via a proprietary interface 8. Independent clients 99, 99a themselves contributing special functionality but not equipped directly with functionality for operating and monitoring can also be connected to the system 1 via a proprietary interface 8 and can access process information data PI. The data filed in the database 4 can hereby be represented and processed on, for example, special analysis clients possessing specific evaluating, analyzing, statistical, and graphical functionality.

Standard programs such as, for example, an office environment from Microsoft, can likewise be used. The provision of global information about the plant's current status and about the plant's history with reference to the production process is consequently possible at any time. Access can herein be effected on the one hand via the proprietary O&M interfaces and, on the other hand, also through remoting the relevant generic database interfaces.

A hybrid interface enabling direct access to the data of the database 4 and access to data of the system 1 for operating and monitoring is also conceivable. The system 1 overall enables a plant's process information data PI to be accessed at any time and anywhere over clients 9,9a,99,99a of multifarious kinds for the purpose, on the one hand, of operating the plant and, on the other hand, of supplying information.

To summarize, the invention relates to a system 1 for operating and monitoring a production process PP and for filing process data for a historian system. O&M functionality and historian functionality are integrated in a system 1. A historian database 4 serves to store process information data PI. Accessing of the production process PP and accessing of data filed on a long-term basis is enabled in one system 1. The process information data PI has to be collected once only by the respective devices 5. The historian system benefits from the O&M system's redundancy. Special multiplexer components 11 ensure transparent concealment of underlying systems. The system 1 is internet-enabled 10 and suitable for use by any clients 9,9a,99,99a. Remoting of the database interfaces enables the use of commercially available historian clients in internet scenarios.

1.-24. (canceled)

25. A system for operating and monitoring a production process, comprising:
a first mechanism for providing process information data acquired from automation devices or automation systems and/or diagnostic devices or diagnostic systems and/or further devices;
a device for preprocessing and/or representing the acquired process information data for at least one user of the system; and
a historian database for archiving the acquired process information data for evaluating and/or representing the archived process information data.

26. The system as claimed in claim 25, wherein the system is provided for coupling to the automation devices or, as the case may be, systems and/or diagnostic devices or, as the case may be, systems and/or further devices via a data transmission device.

27. The system as claimed in claim 25, wherein the system further comprises a second mechanism for generating alarms and/or events.

28. The system as claimed in claim 25, wherein the system further comprises at least one interface for communicating with at least one client.

29. The system as claimed in claim 28, wherein the client is provided as a web client for communicating via the Internet and/or an intranet.

30. The system as claimed in claim 29, wherein a browser is provided as the web client.

31. The system as claimed in claim 28, wherein the clients are embodied as SCADA clients of the system for operating and monitoring.

32. The system as claimed in claim 28, wherein the clients are embodied as clients that are independent of the system for operating and monitoring.

33. The system as claimed in claim 32, wherein the independent clients are embodied as historian clients having analyzing and/or statistical and/or graphical functionality for evaluating and/or representing the archived process information data.

34. The system as claimed in claim 32, wherein the functionality of the independent clients is integrated in the SCADA clients of the system for operating and monitoring.

35. The system as claimed in claim 32, wherein the functionality of the SCADA clients is integrated in the independent clients.

36. The system as claimed in claim 32, wherein the functionality of the clients is integrated in standard applications.

37. The system as claimed in claim 25, wherein the database is adapted for fast and/or central archiving of the acquired process information data.

38. The system as claimed in claim 37, wherein the database is designed as a relational database.

39. The system as claimed in claims 37, wherein access to the database is provided by SQL queries via standard interfaces.

40. The system as claimed in claim 25, wherein the process information data archived in the database is provided for accessing by clients communicating with the system.

41. The system as claimed in claim 39, wherein Remoting of the standard interfaces of the database is provided.

42. The system as claimed in claim 25, wherein the system and the clients are provided for bi-directional web communication.

43. The system as claimed in claim 25, wherein the clients are provided for entering specifications and/or setpoint values for controlling the production process.

44. The system as claimed in claim 25, wherein the system for operating and monitoring is provided for managing users of the system and/or for planning process communication and/or a security system.

45. The system as claimed in claim 25, wherein the system for operating and monitoring is of redundant design, with redundancy also existing for independent clients.

46. The system as claimed in claim 25, further comprising at least one multiplexer component for concealing a redundancy and/or a plurality of data servers.

47. A database for archiving acquired process information data for evaluating and/or representing the filed process information data, wherein the database being provided for integration in a system for operating and monitoring of a production process as claimed in claim 25.

48. A computer program product for operating and monitoring a production process by a system as claimed in claim 25.
